(19) United States
(12) Patent Application Publication
(10) Pub. No.: US 2012/0227523 A1
(43) Pub. Date: Sep. 13, 2012

(54) SHIFTING APPARATUS

(75) Inventor: Kuo-Ming Tseng, Hsinchu (TW)

(73) Assignee: CORETRONIC DISPLAY SOLUTION CORPORATION, Hsinchu (TW)

(21) Appl. No.: 13/043,477

(22) Filed: Mar. 9, 2011

(51) Int. Cl. F16H 25/08

(52) U.S. Cl. 74/89.23

(57) ABSTRACT

A shifting apparatus including a base, first and second shifting elements, a pushing element, a fixed portion, and two screws is provided. The fixed portion fixed on the base has two trenches extending along first and second directions perpendicular to each other. The first shifting element is slidably disposed on the base along the first direction. The second shifting element is slidably disposed on the first shifting element along the second direction. The pushing element is slidably disposed in the two trenches. One screw screwed on the fixed portion along the second direction is capable of pushing the pushing element to move along the two trenches, such that the first shifting element is pushed by the pushing element to shift along the first direction. Another screw screwed on the first shifting element along the second direction is capable of pushing the second shifting element to shift along the second direction.

### BACKGROUND

1. Field of the Invention

The invention relates to a shifting apparatus. Particularly, the invention relates to a shifting apparatus adapted to load a testing platform.

2. Description of Related Art

A medical ultrasound has advantages such as safety and low cost. Thus, the medical ultrasounds are widely used during clinical diagnosis, for example, heart, abdomen, and maternity ultrasound check ups. In addition, the medical ultrasound may be further used for different medical experiments.

For example, the medical ultrasound may be used on an experimental living body (i.e. mouse) for image scanning. The user may install a testing platform carrying the mouse onto a shifting apparatus, so that the mouse may be shifted through the shifting apparatus, so as to perform ultrasound scan to various parts of the mouse. In detail, the shifting apparatus includes a base, a first shifting element slidably disposed on the based, and a second shifting element slidably disposed on the first shifting element, where the first shifting element is suitable for shifting relative to the base along a first direction, and the second shifting element is suitable for shifting relative to the first shifting element along a second direction perpendicular to the first direction, so as to drive the testing platform carried by the second shifting element to move along the first direction and the second direction.

In detail, two screws may be configured on the shifting apparatus, and the two screws are respectively used to drive the first shifting element and the second shifting element. Since the first shifting element and the second shifting element are required to be respectively shifted along the first direction and the second direction, the two screws are generally configured to respectively extend along the first direction and the second direction, and are respectively located at different sides of the shifting apparatus. According to such configuration, the user may not operate the two screws at the same side of the shifting apparatus, and need to screw the two screws along different directions, and therefore, inconvenience in operation may be caused.

Taiwan Patent No. TW M283481 discloses a working platform, where an adjustment mechanism thereof drives the working platform for lateral movement through a gear set. U.S. Pat. No. 4,936,655 discloses an alignment clip of an optical apparatus, where two rotary driving systems are used to respectively control movements of two directions, and the two rotary driving systems are locates at a same side of the apparatus.

### SUMMARY OF THE INVENTION

The invention is directed to a shifting apparatus, and the shifting apparatus may be conveniently operated.

Additional aspects and advantages of the invention will be set forth in the description of the techniques disclosed in the invention.

In order to achieve one or a portion of or all of the objects or other objects, an embodiment of the invention provides a shifting apparatus including a base, a shifting assembly, a pushing element, a fixed portion, a first screw, and a second screw. The shifting assembly includes a first shifting element and a second shifting element. The first shifting element is slidably disposed on the base along a first direction. The second shifting element is slidably disposed on the first shifting element along a second direction perpendicular to the first direction. The fixed portion is fixed on the base. The fixed portion has a first trench and a second trench connected to each other. The first trench extends along the first direction. The second trench extends along the second direction. A part of the pushing element is slidably disposed in the first trench along the first direction and leans against the first shifting element. Another part of the pushing element is slidably disposed in the second trench along the second direction. The first screw is screwed on the fixed portion along the second direction. One end of the first screw extends into the second trench and leans against the pushing element. The first screw pushes the pushing element to move along the first trench and the second trench when the first screw is screwed, so as to drive the pushing element to push the first shifting element to shift relative to the base along the first direction. The second screw is screwed on the first shifting element along the second direction. One end of the second screw leans against the second shifting element. The second screw pushes the second shifting element to shift relative to the first shifting element along the second direction when the second screw is screwed.

In summary, the embodiment or embodiments of the invention may have at least one of the following advantages. In the above embodiment of the invention, the second screw is screwed on the first shifting element along the second direction, so as to drive the second shifting element to shift relative to the first shifting element along the second direction. The fixed portion has the first trench and the second trench respectively extending along the first direction and the second direction, and the pushing element is slidably disposed in the first trench and the second trench, so that in case that the first screw is screwed on the fixed portion along the second direction, the first screw may drive the pushing element to push the first shifting element to shift relative to the base along the first direction. In this way, the first screw and the second screw may be configured along the same direction, so that the user may screw the first screw and the second screw along the same direction, so as to further improve the operation convenience of the shifting apparatus.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a three-dimensional view of a shifting apparatus according to an embodiment of the invention.

FIG. 2 is a three-dimensional view of a part of components of the shifting apparatus of FIG. 1.

FIG. 3 is a three-dimensional view of a part of components of the shifting apparatus of FIG. 1.

FIG. 4 is a partial schematic diagram of the shifting apparatus of FIG. 1.

FIG. 5 is a partial schematic diagram of the shifting apparatus of FIG. 1.

### DETAILED DESCRIPTION OF DISCLOSED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

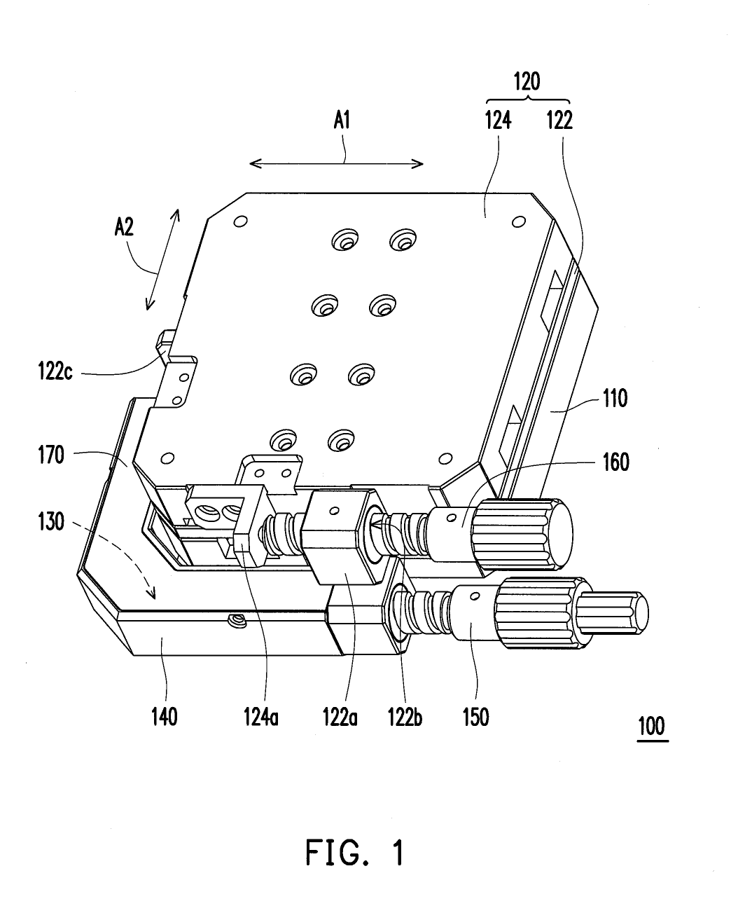

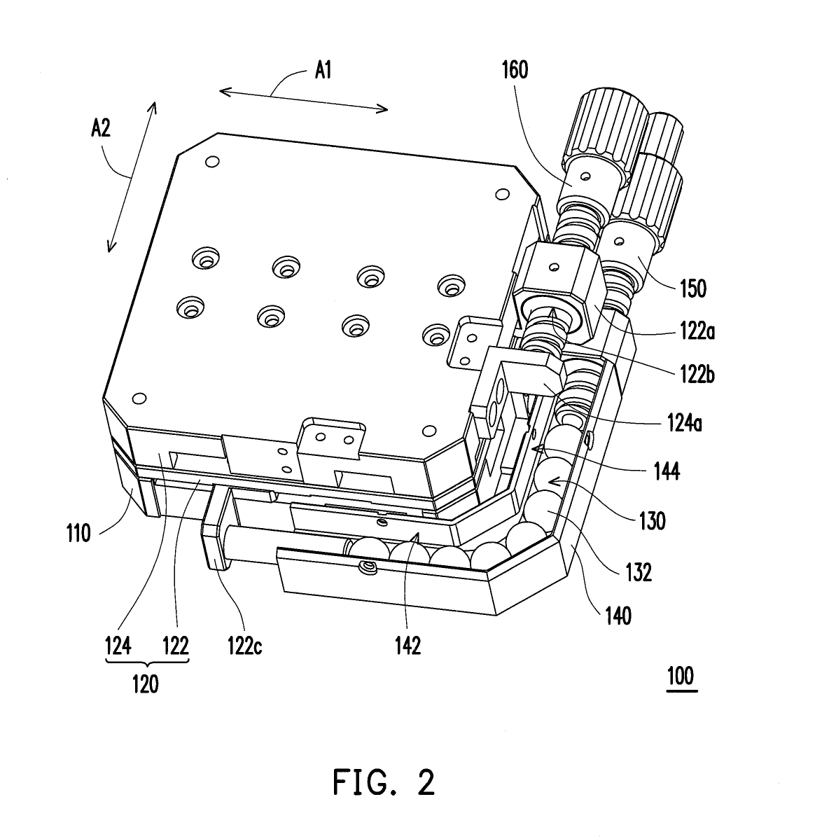

Referring to FIG. 1 and FIG. 2, the shifting apparatus 100 of the present embodiment includes a base 110, a shifting assembly 120, a pushing element 130, a fixed portion 140, a first screw 150, and a second screw 160. The shifting assembly 120 includes a first shifting element 122 and a second shifting element 124. The first screw 150 is used to drive the first shifting element 122 to shift relative to the base 110 along a first direction A1, and the second screw 160 is used to drive the second shifting element 124 to shift relative to the first shifting element 122 along a second direction A2.

In detail, the first shifting element 122 is slidably disposed on the base 110 along the first direction A1. The second shifting element 124 is slidably disposed on the first shifting element 122 along the second direction A2 perpendicular to the first direction A1. The fixed portion 140 is fixed on the base 110, and has a first trench 142 and a second trench 144 connected to each other, where the first trench 142 extends along the first direction A1, and the second trench 144 extends along the second direction A2. A part of the pushing element 130 is slidably disposed in the first trench 142 along the first direction A1 and leans against the first shifting element 122, and another part of the pushing element 130 is slidably disposed in the second trench 144 along the second direction A2. The first screw 150 is screwed on the fixed portion 140 along the second direction A2, where one end of the first screw 150 extends into the second trench 144 and leans against the pushing element 130. The second screw 160 is screwed on the first shifting element 122 along the second direction A2, and one end of the second screw 160 leans against the second shifting element 124.

The first screw 150 pushes the pushing element 130 to move along the first trench 142 and the second trench 144 when the first screw 150 is screwed, so as to drive the pushing element 130 to push the first shifting element 122 to shift relative to the base 110 along the first direction A1. On the other hand, the second screw 160 pushes the second shifting element 124 to shift relative to the first shifting element 122 along the second direction A2 when the second screw 160 is screwed.

In case that the first screw 150 is screwed on the fixed portion 140 along the second direction A2, the first screw 150 is capable of driving the first shifting element 122 to shift relative to the base 110 along the first direction A1 through the pushing element 130. In this way, the first screw 150 and the second screw 160 may be configured along the same direction, so that a user may screw the first screw 150 and the second screw 160 along the same direction, and therefore operation of the shifting apparatus 100 may be more convenient. Moreover, as shown in FIG. 1 and FIG. 2, the first screw 150 and the second screw 160 may be disposed at a same side of the shifting assembly 120, so that the user may screw the first screw 150 and the second screw 160 from the same side of the shifting assembly 120, so as to further improve the operation convenience.

Referring to FIG. 2, in the present embodiment, the pushing element 130 includes a plurality of rigid components 132, and the rigid components 132 are configured along the first trench 142 and the second trench 144, so that the first screw 150 is suitable for pushing the rigid components 132 to move along the first trench 142 and the second trench 144. The rigid components 132 are, for example, steel balls, and inner diameters of the first trench 142 and the second trench 144 may be designed to be equal to an outer diameter of each of the steel balls, so that the rigid components 132 may be stably moved in the first trench 142 and the second trench 144.

Further, the first shifting element 122 has a first bump 122a, and the second shifting element 124 has a second bump 124a. The first bump 122a has a screw hole 122b, and the second bump 124a is aligned to the screw hole 122b. The second screw 160 is adapted to be screwed to the screw hole 122b along the second direction A2 and leans against the second bump 124a, so that the second bump 124a is adapted to be pushed by the second screw 160 to drive the second shifting element 124 to shift relative to the first shifting element 122.

Moreover, the first shifting element 122 has an extending portion 122c, and the extending portion 122c extends into the first trench 142 along the first direction A1 and leans against the pushing element 130, so that the extending portion 122c is adapted to be pushed by the pushing element 130 to drive the first shifting element 122 to shift relative to the base 110. As shown in FIG. 1, the shifting apparatus 100 of the present embodiment further includes a cover 170, and the cover 170 is disposed on the fixed portion 140 and covers the first trench 142 and the second trench 144 shown in FIG. 2, so as to prevent the rigid components 132 from falling off from the fixed portion 140.

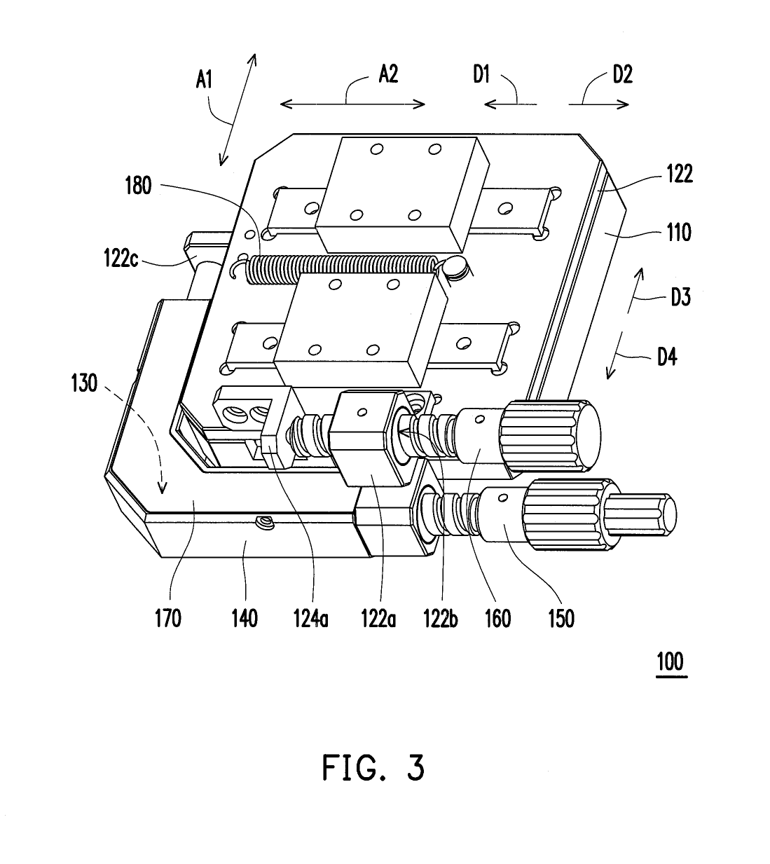

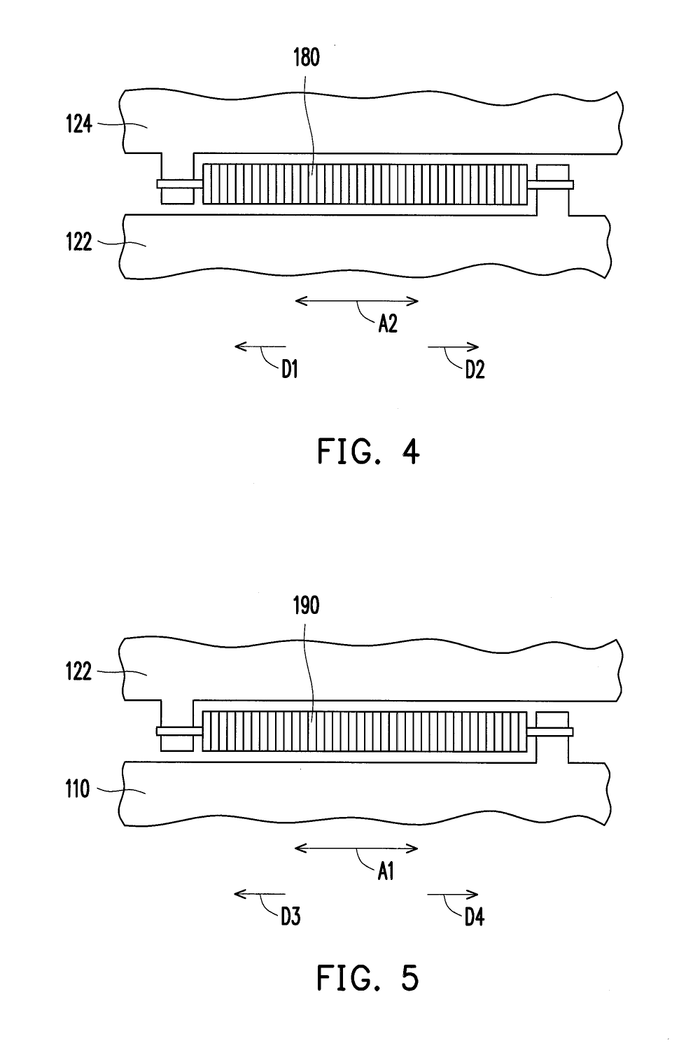

For clarity's sake, the second shifting element 124 of FIG. 1 is not illustrated in FIG. 3. Referring to FIG. 3 and FIG. 4, the shifting apparatus 100 of the present embodiment further includes an elastic element 180, and the elastic element 180 is connected between the first shifting element 122 and the second shifting element 124. After the second screw 160 pushes the second shifting element 124 to shift relative to the first shifting element 122 along the second direction A2, the elastic element 180 is stretched to store elastic potential energy, so as to provide an elastic force for restoring a position of the second shifting element 124. In other words, the second shifting element 124 is pushed by the second screw 160 to shift relative to the first shifting element 122 along a direction D1, and is driven by the elastic force of the elastic element 180 to shift relative to the first shifting element 122 along a direction D2.

Referring to FIG. 5, the shifting apparatus 100 of the present embodiment further includes an elastic element 190, and the elastic element 190 is connected between the first shifting element 122 and the base 110. After the pushing element 130 pushes the first shifting element 122 to shift relative to the base 110 along the first direction A1, the elastic element 190 is stretched to store elastic potential energy, so as to provide an elastic force for restoring a position of the first shifting element 122. In other words, the first shifting element 122 is pushed by the pushing element 130 to shift relative to the base 110 along a direction D3, and is driven by the elastic force of the elastic element 190 to shift relative to the base 110 along a direction D4.

For example, a testing platform may be disposed on the second shifting element 124 of the shifting apparatus 100 of the present embodiment, and a user may put an object on the testing platform, so that the object may be shifted relative to the base 110 along with movements of the second shifting element 124 and the first moving element 122. When the shifting apparatus 100 of the present embodiment is applied in a medical ultrasound scanning experiment, the object may be a living object (for example, a mouse) used for the experiment, though the invention is not limited thereto, and the shifting apparatus 100 may also be used to shift other suitable objects for the experiment or other usages.

In summary, the embodiment or embodiments of the invention may have at least one of the following advantages. In the above embodiment of the invention, the second screw is screwed on the first shifting element along the second direction, so as to drive the second shifting element to shift relative to the first shifting element along the second direction. The fixed portion has the first trench and the second trench respectively extending along the first direction and the second direction, and the pushing element is slidably disposed in the first trench and the second trench, so that the first screw may drive the pushing element to push the first shifting element to shift relative to the base along the first direction in case that the first screw is screwed on the fixed portion along the second direction. In this way, the first screw and the second screw may be configured along the same direction, so that the user may screw the first screw and the second screw along the same direction, so that the operation of the shifting apparatus may be more convenient. Moreover, the first screw and the second screw may be disposed at a same side of the shifting assembly, so that the user may screw the first screw and the second screw from the same side of the shifting assembly, so as to further improve the operation convenience.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A shifting apparatus, comprising:
a base;
a shifting assembly, comprising:
a first shifting element, slidably disposed on the base along a first direction; and
a second shifting element, slidably disposed on the first shifting element along a second direction perpendicular to the first direction;
a fixed portion, fixed on the base, and having a first trench and a second trench connected to each other, wherein the first trench extends along the first direction, and the second trench extends along the second direction;
a pushing element, wherein a part of the pushing element is slidably disposed in the first trench along the first direction and leans against the first shifting element, and another part of the pushing element is slidably disposed in the second trench along the second direction;
a first screw, screwed on the fixed portion along the second direction, wherein one end of the first screw extends into the second trench and leans against the pushing element, and the first screw pushes the pushing element to move along the first trench and the second trench when the first screw is screwed, so as to drive the pushing element to push the first shifting element to shift relative to the base along the first direction; and
a second screw, screwed on the first shifting element along the second direction, wherein one end of the second screw leans against the second shifting element, and the second screw pushes the second shifting element to shift relative to the first shifting element along the second direction when the second screw is screwed.

2. The shifting apparatus as claimed in claim 1, wherein the first screw and the second screw are located at a same side of the shifting assembly.

3. The shifting apparatus as claimed in claim 1, wherein the pushing element comprises a plurality of rigid components, and the rigid components are disposed in the first trench and the second trench.

4. The shifting apparatus as claimed in claim 3, wherein an inner diameter of the first trench and an inner diameter of the second trench are respectively equal to an outer diameter of each of the rigid components.

5. The shifting apparatus as claimed in claim 3, wherein each of the rigid components is a steel ball.

6. The shifting apparatus as claimed in claim 1, further comprising an elastic element connected between the base and the first shifting element, wherein the elastic element provides an elastic force for restoring a position of the first shifting element after the pushing element pushes the first shifting element to shift relative to the base along the first direction.

7. The shifting apparatus as claimed in claim 1, further comprising an elastic element connected between the first shifting element and the second shifting element, wherein the elastic element provides an elastic force for restoring a position of the second shifting element after the second screw pushes the second shifting element to shift relative to the first shifting element along the second direction.

8. The shifting apparatus as claimed in claim 1, wherein the first shifting element has a first bump, the second shifting element has a second bump, the first bump has a screw hole, the second bump is aligned to the screw hole, and the second screw is screwed to the screw hole along the second direction and leans against the second bump.

9. The shifting apparatus as claimed in claim 1, wherein the first shifting element has an extending portion extending into the first trench along the first direction and leans against the pushing element.

10. The shifting apparatus as claimed in claim 1, further comprising a cover disposed on the fixed portion and covering the first trench and the second trench.
